(19) United States
(12) Patent Application Publication
(10) Pub. No.: US 2004/0191453 A1
(43) Pub. Date: Sep. 30, 2004

(54) SYSTEMS AND METHODS FOR GENERATING AN IMAGE ON A RECORDING LAYER FOR USE WITH A PROTECTIVE LAYER

(76) Inventors: Douglas J. Baxendell, Rochester, NY (US); Billy T. Stojanovski, Webster, NY (US); Michael Cook, Waterloo, NY (US); Bernard Leibman, Webster, NY (US)

Correspondence Address: OLIFF & BERRIDGE, PLC., P.O. BOX 19928, ALEXANDRIA, VA, 22320, US

(21) Appl. No.: 10/249,226

(22) Filed: Mar. 24, 2003

(51) Int. Cl. B32B 9/00; B32B 31/00

(52) U.S. Cl. 428/40.1; 156/277; 156/384

(57) ABSTRACT

Systems and methods for generating an image on a recording medium having a recording layer that is layered by a protective layer. The recording medium includes a substrate and a recording layer with pores. The recording layer is attached to the substrate. The recording medium is processed by an image recording device that records an image on the recording layer. When the protective layer is applied to the recording layer, the image substantially remains the same.

### BACKGROUND OF INVENTION

1. Field of Invention

This invention relates to a recording medium used for generating decorative appliques in low volume manufacturing. In particular, the recording medium includes a lightweight porous sheet, temporarily adhered to a substrate, having an image printed thereon by an image recording device, such as an ink jet printer.

2. Description of Related Art

Encapsulated appliques are used extensively, for example, in the composite sporting goods market to add a permanent logo, or applique, to a product. Typical products include, for example, surfboards, canoes, kayaks and hockey sticks. Frequently, numerous different types of appliques are applied to a single product for aesthetic appeal. Appliques are usually screen printed on a rice paper or a synthetic equivalent. After the applique has been placed on a surface of the product and an epoxy resin is layered over the applique, the rice paper absorbs the epoxy resin layered over the applique forming a permanent bond between the applique and a surface of the object. The rice paper turns transparent once encapsulated by the epoxy resin.

Conventionally, photo charges, set-up and screening charges make production of applique logos expensive in medium size runs and are simply cost prohibitive in very short runs. For those products having numerous appliques, the set-up and run-off costs can be extremely high. In addition, the natural or synthetic rice paper used to carry these graphics is very flexible and will not pass through conventional image recording devices, such as an inkjet printer.

In the alternative to screening on rice paper, vinyl stickers were produced to display a logo. However, the costs associated with producing vinyl stickers are also high where only a few copies are desired. In addition, the adhesive bond between the vinyl sticker and the surface upon which the sticker was adhered has the tendency to deteriorate when subjected to harsh conditions. Examples of such harsh conditions that affect the adhesive bond of the vinyl sticker with the surface upon which it is attached include, for example: salt water and sand on a surfboard; the turbulence of water on kayaks and canoes; and the pounding of a hockey stick against other objects, such as a hockey puck.

### SUMMARY OF THE INVENTION

The disadvantages associated with each of the above-mentioned conventional modes for producing appliques have been overcome by the systems and methods according to this invention.

Although some elements described in the exemplary embodiments may be, at least individually, well known to those skilled in the art, the novelty and innovation of this solution is at least the combination of known items to achieve a previously unknown result. Various exemplary embodiments of the systems and methods of this invention recognize a need for greatly reducing the costs associated with producing one-off or limited run appliques. The present invention also provides for the production of an applique much easier, faster and more conveniently than before, for example, by an individual at his or her personal computer.

The systems and methods of this invention provide printing individual appliques with an image recording device on a recording medium that includes a recording layer attached to a substrate.

The system and methods according to this invention could be applied widely throughout various different industries. In addition to the conventional uses listed above, this invention can also be applied for a variety of diverse uses, including for example, in the boating industry, as a custom designed boat name created with software publishing type software and printed for only a few dollars worth of paper; and/or to produce a novelty magnet having a desired image printed thereon.

The systems and methods according to this invention separately provide a recording medium including a substrate and a recording layer with pores. The recording layer is attached to the substrate. The recording medium is processed by an image recording device that records an image on the recording layer. When a protective layer is applied to the recording layer, the image substantially remains the same.

The systems and methods according to this invention separately provide a method of making an applique. The method includes selecting an image with an image data source and processing the image. Then, printing the image to a recording medium with an image recording device, wherein the recording medium includes a recording layer adhered to a substrate. Then, separating the recording layer with the image from the substrate and placing the recording layer and image on an object surface, and applying a protective layer to the recording layer such that the image substantially remains the same and is not visually distorted as the protective layer permanently cures.

The systems and methods according to this invention separately provides applying an ultraviolet inhibitor to at least one of the ink, the protective layer and a clear coat to guard against ultraviolet radiation.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of the systems and methods of this invention described in detail below, with reference to the attached drawing figures, in which.

FIG. 1 illustrates an exemplary image printing system according to this invention.

FIG. 2 illustrates removal of a recording layer from a substrate according to this invention.

FIG. 3 illustrates a cross-section view of a recording layer according to this invention.

FIG. 4 illustrates a perspective view of an applique on a surface of an object according to this invention; and.

FIG. 5 illustrates a cross-section view of the applique on the surface of the object according to this invention; and.

FIG. 6 is a block diagram of an exemplary method of making an applique accordance with the present invention.

### DETAILED DESCRIPTION OF EXEMPLARY EMBODIMENTS

In various exemplary embodiments, the systems and methods according to this invention generate individual appliques with an image recording device on a recording medium for use with an epoxy matrix.

The following description of an exemplary embodiment and various alternatives is by way of example only, and is not intended to be exhaustive or limiting. On the contrary, the exemplary embodiment and various alternatives are intended to provide those skilled in the art with a full understanding of this invention.

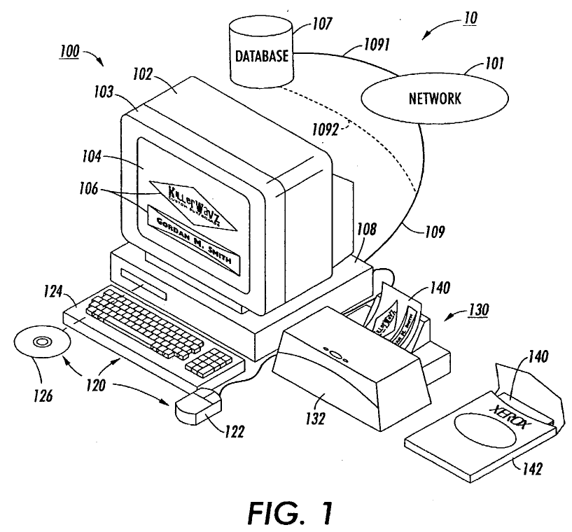

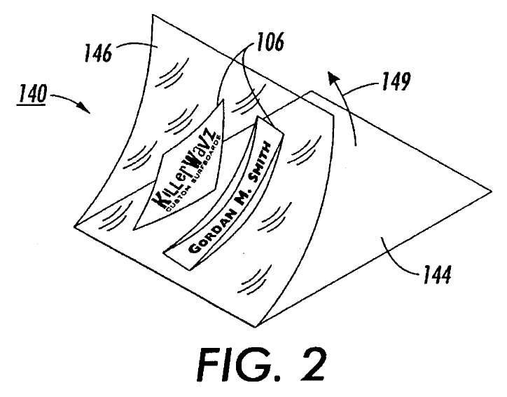

FIG. 1 illustrates an exemplary image printing system 10 according to this invention. The image printing system 10 includes an image data source 100, an image recording device 130 and a recording medium 140 from a print medium stock 142. As shown in FIG. 2, the recording medium 140 is composed of a recording layer 146 and a substrate 144.

According to this exemplary embodiment, the image data source 100 of FIG. 1 includes a monitor 102 with a display screen 104, an image processing apparatus 108 and input devices 120. In various exemplary embodiments, the input devices 120 may include, for example, a mouse 122, a keyboard 124, and any other known or later developed type of input device, such as a stylus, a keypad and a touchscreen.

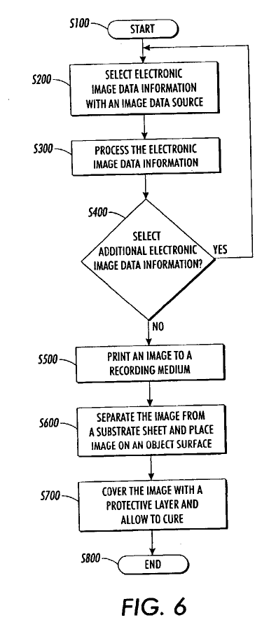

As shown in FIG. 1, the image data source 100 is implemented on a programmed general purpose computer 103. However, the image data source 100 can also be implemented on a special purpose computer, a programmed microprocessor or a microcontroller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device capable of implementing a finite state machine that is turn capable of implementing the flow chart shown in FIG. 6, can be used to implement the image data source 100.

The image processing apparatus 108 of the image data source 100 includes a link 109. The link 109 can be any known or later developed device or system for connecting the image data source 100 to a database 107 that stores electronic image data information, such as images. The link 109 can be a direct connection 1092, an indirect connection 1092 over a network 101, for example, a wide area network or a local area network, a connection over an intranet, a connection over the Internet, or a connection over any other distributed processing network or system. In general, the link 109 can be any known or later developed connection system or structure usable to connect the image data source 100 to a local or remote database 107.

Further, it should be appreciated that the link 109 of the image printing system 10 connecting a memory of the image processing apparatus 108 can be a wired or wireless link to a network (not shown).

In the alternative to capturing the electronic image data information through the link 109, the electronic image data information can be stored on and recalled from electronic storage devices, such as a CD/DVD 126, or any type of known or later developed device that stores electronic image data information.

In various exemplary embodiments of the systems and methods according to this invention, the image data source 100 can be a digital camera, a scanner, or a locally or remote located computer, or any other known or later developed device that is capable of generating electronic image data information. Similarly, the image data source 100 can be any suitable device that stores and/or transmits electronic image data information, such as a client or a server of a network.

It should also be appreciated that, while the electronic image data information could have been generated at any time in the past, the electronic image data information can be generated at the time of printing an image from an original physical document. Moreover, the electronic image data information need not have been generated from the original physical document, but could have been created from scratch electronically. The image data source 100 is thus any known or later developed device, which is capable of supplying electronic image data information, for example, at the general purpose computer 103 or capable of supplying electronic image data information over the link 109 to the image processing apparatus 108. The image data information can include information, such as for example, images, text, or any other known or later developed type of image data information.

The image processing apparatus 108, retrieves the electronic image data information selected by the input devices 120. The image processing apparatus 108 can perform various processing operations, such as, re-dimensioning the size of the image changing attributes, copying, segmenting, aggregating or any other known or later developed technique for processing the electronic image data information. Various types of image processing software can be used to perform the various processing operations. The image processing software can include conventional publishing type software that is capable of processing rasterized or vector imaging, such as for example, Adobe Illustrator™, Adobe Pagemaker™, Photoshop™, Macromedia Freehand™, QuarkExpress™ or any other type of publishing type software capable of manipulating captured electronic image data information.

In various exemplary embodiments, the image recording device 130 can be any device that is capable of outputting or storing the processed image data information generated according to the systems and methods of this invention, such as a printer, a copier or other image forming devices, a facsimile device, a display device, a memory, or the like.

As shown in the exemplary embodiment of FIG. 1, the image recording device 130 is a printer 132. The printer 132 can include various types of printers, such as a black and white printer, a color printer, an ink jet printer, a laser printer or any other type of printing device known or later developed capable of working with the image printing system 10 of this invention.

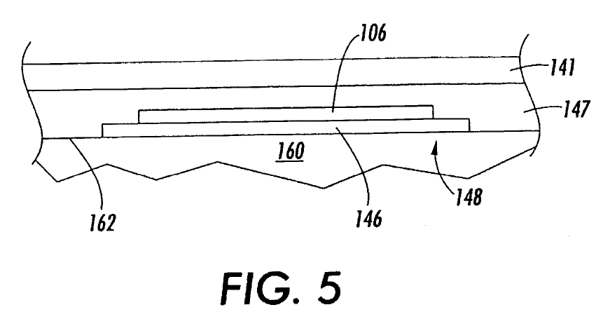

A sheet of the recording medium 140 from the print medium stock 142 is fed through the image recording device 130 and ink in the printer 132 produces an image 106 on the recording medium 140. The ink used in the printer 132 to produce the image 106 can be any type of conventional ink used in a printing device. It is also an object of this invention to disperse the ink onto the recording layer 146 such that the image 106 formed by the ink is substantially unaffected, for example, from smearing, fading, blurring, bleeding, etc., both when the ink is applied to the recording layer 146 and when a protective layer 147 (as shown in FIG. 5) is applied over the recording layer 146 and is allowed to cure.

According to the various exemplary embodiments, one way that distortion of the ink can be prevented is by controlling a predetermined amount of saturation of the ink on the recording layer 146. The predetermined amount of saturation should take into account various factors, including, for example, the material of the surface of an object that the image 106 is to be attached to, the chemical interaction characteristics between the protective layer 147 and the ink, the absorption characteristics of the recording layer 146 (for example, a clay content), and any other environmental factor that may affect the saturation of the ink. The amount of the saturation can be adjusted in a variety of ways now known or later developed, for example, by adjusting software controls in the printer.

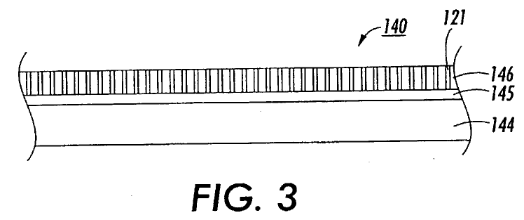

FIG. 2 illustrates a perspective view of the recording medium 140. The recording medium 140 includes the recording layer 146 and the substrate 144. The recording layer 146 and the substrate 144 are adhered with an adhesive 145 (as shown in FIG. 3) to each other in an easy to remove manner. That is, a peeling force required to separate the recording layer 146 from the substrate 144 is low enough so that an individual can manually separate the recording layer 146 from the substrate 144 by hand, yet strong enough so that the recording layer 146 will not separate from the substrate 144 when it is fed through the printer 132. The adhesive 145 is chosen that does not affect the ink of the image 106 printed on the recording layer 146.

The recording layer 146 is composed of a lightweight porous sheet. The recording layer 146 is substantially thin and turns transparent when the protective layer 147 is applied to the recording layer 146. The recording layer 146 can be any type of medium that is capable of absorbing a quantity of ink from the image recording medium 130 and which turns transparent when it is covered and interacts with the protective layer 147, such as for example, a polyester base paper, a synthetic rice paper, a surfacing veil, i.e., similar to a material used as a protective covering for a toilet seat generally found in public restrooms, or any other known or later developed equivalent medium that can be used by this invention. The recording layer 146 is highly porous and highly absorbent. The recording layer 146 is sufficiently porous to enable any air trapped under the recording layer 146 to escape through pores 121 (as shown in FIG. 3) in the recording layer 146 and the protective layer 147 to the atmosphere when the protective layer 147 is applied over the recording layer 146.

In the alternative, for applications where a clear, or nearly clear, applique 148 is not desired, such as when laminating over a dark surface, an opaque colored recording layer, such as, a white, a dark or a metallic looking medium can be used as the recording layer 146. The recording layer 146 would include similar absorption and porosity characteristics as described above. Thus, when the protective layer 147 is applied to the recording layer 146, the recording layer 146 will not turn transparent, but instead will provide a aesthetically visible background upon which the image 106 is printed.

The substrate 144 is composed of, for example, a sheet of paper. Because the recording layer 146 is generally too thin to be fed through the image recording device 130 alone, the substrate 144 is attached to the recording layer 146 to provide the necessary rigidity for the recording layer 146 to be fed through the image recording device 130. The substrate 144 can include, for example, a single piece of paper stock or any other known or later developed type of medium sufficient to support the recording layer 146 through the image recording device 130.

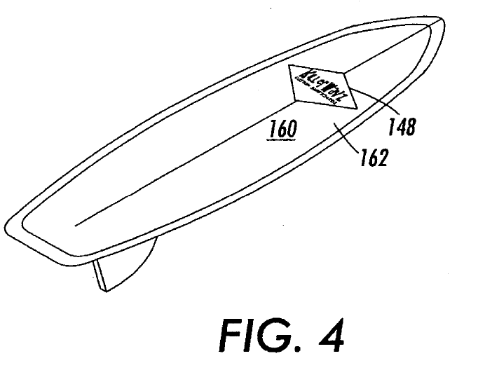

FIG. 2 shows removal of the recording layer 146 from the substrate 144 according to this invention. After the recording medium 140 has been fed through the printer 132 and an image 106 has been printed on the recording layer 146, the recording medium 140 can be trimmed to approximately the size of the image 106 to form an applique 148 (as shown in FIG. 4). Then, the recording layer 146 can be peeled away from the substrate 144, such as in a direction shown by arrow 149. The substrate 144 can then be discarded. Alternatively, after the image 106 has been printed on the recording layer 146, the recording layer 146 can be separated from the substrate 144 and the recording layer 146 can be trimmed around the image 106 to form the applique 148 prior to placing the applique 148 on a surface 162 of an object 160 (as shown in FIGS. 4 and 5).

Although the recording medium 140 shown in FIG. 2 is a sheet, it is also contemplated by this invention that the recording medium 140 can be produced as a continuous roll manufactured for larger decorations, or any other shape for the recording medium 140 to accommodate printing thereon by the image recording device 130 described above.

FIG. 3 illustrates a cross-section view of a recording medium 140 according to this invention. The recording medium 140 shows the recording layer 146 attached to the substrate 144 by the adhesive 145. Alternatively, the substrate 144 can be attached to the lightweight porous sheet 146 by the adhesive 145. The recording layer 146 includes pores 121 through which air bubbles can escape to the atmosphere when the protective layer 147 is applied. The recording layer 146 is temporarily tacked to the substrate 144 by the adhesive 145 having a low peeling force in such a manner that it can be manually peeled away from the substrate, as shown by the arrow 149 in FIG. 2.

FIG. 4 illustrates a perspective view of the applique 148 on a surface 162 of an object 160 according to the systems and methods of this invention. The applique 148 is placed onto the surface 162 of the object 160. The applique 148 is then laminated, or covered over with the protective layer 147. The applique is made up of the recording layer 146 and the image 106 printed thereon. The protective layer 147 can include, for example, a fiberglass resin, a polyester resin, an epoxy resin or any other type of resin, or matrix, capable of providing lamination of the applique 148. According to the systems and methods of this invention, neither the protective layer 147, the recording layer 146, or any other component part of this invention will attack the styrene in the ink.

The recording layer 146 uniformly absorbs the protective layer 147 such that air bubbles are substantially untrapped and allowed to pass through the pores 121 in the recording layer 146. As the recording layer 146 absorbs and is encapsulated by the protective layer 147, the recording layer 146 turns transparent. The protective layer 147 is allowed to cure and forms a permanent waterproof logo that will protect the image from external harsh conditions.

The ink used in the printer 132 to produce the image 106 is not visually affected by a chemical interaction between the ink and the protective layer 147. In other words, the image 106 of the applique 148 is not distorted, and is substantially unaffected, after the protective layer 147 has cured over the applique 148.

According to another aspect of this invention, it is also possible to incorporate an ultraviolet (UV) inhibitor directly into the ink to prevent fading when subjected to ultraviolet radiation. The ultraviolet inhibitor an also be incorporated into the resin or provided as a clear coat over the resin for the same purpose.

FIG. 5 illustrates a cross-section view of the encapsulation of the applique 148 onto the surface 162 of the object 160 according to this invention. In particular, the image 106 on the applique 148, backed by the recording layer 146, is placed on the surface 162 of the object 160. The protective layer 147 is then laid over the applique 148 and permanently encapsulates the applique 148 as the protective layer 147 is allowed to cure. In addition, an additional sealer 141, or clear coat, having an ultraviolet inhibitor, can be applied over the protective layer 147 to protect the applique 148 from ultraviolet radiation.

FIG. 6 shows an exemplary method of making an applique according to the systems and methods of the present invention.

In particular, a control routine begins in step S100. The control routine continues to step S200, where electronic image data information is selected with an image data source, for example, a general purpose computer. The electronic image data information can be selected with a selection device, for example, a button of a keyboard, a mouse, an icon on a touch screen and/or any other known or later developed selection device. The electronic image data information includes, for example, images, text or any other known or later developed type of electronic image data information. In various other exemplary embodiments according to this invention, the electronic image data information can be captured using a software layer, a CCD camera, interaction with a PC, PDA, cell phone, scanner, display, or any other known or later developed mode for capturing electronic image data information. Alternatively, the electronic image data information can be originally created with publishing type software, or any other known or later developed mode for creating electronic image data information. The control routine continues to step S300.

In step S300, the electronic image data information is processed by an image processing unit. Processing may include, for example, customizing the image, redimensioning the size, changing attributes of the image of the captured electronic image data information, or any other known or later developed type of processing. The publishing type software can include commercially available software capable of manipulating rasterized or vector electronic data image information. Control continues to step S400.

In step S400, a determination is made whether to select additional electronic image data information. If so, control returns to step S200 to select additional, electronic image data information to be processed in step S300. Otherwise, control continues to step S5OO.

In step S500, the electronic image data information processed by the image processing unit is converted into an image and printed onto a recording medium by an image recording device. The recording medium is composed of a recording layer attached to a substrate by an adhesive. The recording layer is a lightweight porous sheet that includes, for example, a rice paper, a polyester paper, a synthetic equivalent, or any other known or later developed type of paper that is lightweight and porous and has high absorption characteristics. According to this invention, the recording layer uniformly absorbs ink used to produce the image. Control continues to step S600.

In step S600, the recording layer is separated from the substrate. Separation of the recording layer from the substrate may include selectively trimming the printed image from the surrounding unprinted portion of the recording layer, which is attached to the substrate to form an applique. Then, the applique, or trimmed portion of the recording medium, can be separated from the substrate. The recording layer can be adhered to the substrate with an adhesive disposed between the recording layer and the substrate or vice versa. The adhesive that adheres the recording layer and the substrate can be removed in an easy manner. That is, a peeling force required to separate the recording layer from the substrate is low enough so that an individual can manually separate the recording layer from the substrate by hand, yet strong enough so that the recording layer will not separate from the substrate when it is fed through the printer. The adhesive is chosen that does not affect the ink of the image printed on the recording layer. The ink used to produce the image on the applique also not visually affected by any chemical interaction between the ink and the protective layer. Control then continues to step S700.

In step S700, the applique laminated over with, or encapsulated by, a protective layer and is allowed to cure. The recording layer uniformly absorbs the protective layer, such as for example, a fiberglass resin, a polyester resin, an epoxy resin or any other type of resin, or matrix, capable of providing lamination of the applique. The applique uniformly absorbs the protective layer such that air is allowed to pass through pores in the recording layer and through the protective layer to atmosphere as the protective layer is laid over the recording layer. As the protective layer covers the applique and the protective layer is allowed to cure, the applique is not attacked or visually affected by chemical interaction between the ink and the protective layer. As the protective layer is laid over the applique and is allowed to cure, the recording layer turns transparent and cannot be visually seen.

In the alternative, for applications where a clear, or nearly clear, applique is not desired, such as when laminating over a dark surface, an opaque colored recording layer, such as, a white, a dark or a metallic looking medium can be used as the recording layer. The recording layer would include similar absorption and porosity characteristics as described above. Thus, when the protective layer is applied to the recording layer, the recording layer will not turn transparent, but instead will provide a aesthetically visible background upon which the image is printed. Control then continues to step S800 and the process ends.

While this invention has been described in conjunction with various exemplary embodiments, it is to be understood that many alternatives, modifications and variations would be apparent to those skilled in the art. Accordingly, Applicants intend to embrace all such alternatives, modifications and variations that follow in the spirit and scope of this invention.

1. A recording medium comprising:
a substrate; and
a recording layer with pores and that is attached to the substrate,
wherein the recording medium is processed by an image recording device that records an image on the recording layer; and
when a protective layer is applied to the recording layer, the image substantially remains the same.

2. The recording medium according to claim 1, wherein the substrate is a carrier sheet.

3. The recording medium according to claim 2, wherein the carrier sheet is a piece of paper stock.

4. The recording medium according to claim 1, wherein the recording layer is a lightweight porous sheet.

5. The recording medium according to claim 1, wherein the recording layer and the substrate are attached with an adhesive having a low peeling force.

6. The recording medium according to claim 1, wherein the image recording device is a printer.

7. The recording medium according to claim 6, wherein the printer is an ink jet printer.

8. The recording medium according to claim 1, wherein the protective layer is at least one of a fiberglass resin, a polyester resin and an epoxy resin.

9. The recording medium according to claim 8, wherein when the protective layer is applied to the recording layer, the image remains the same visually and the recording layer turns transparent.

10. The recording medium according to claim 1, wherein an ultraviolet inhibitor can be included in at least one of the ink, the protective layer and a clear coat that covers the protective layer.

11. A system for generating an applique comprising:
an image data source with an image processor connected to a database including electronic image data information;
an image recording device;
a recording medium comprising:
a substrate; and
a recording layer with pores and that is temporarily tacked to the substrate,
wherein after an image is printed on the recording layer by an image recording device, the recording layer is separated from the substrate and placed on a surface of an object, and
when a protective layer is applied to the recording layer, the image substantially remains the same.

12. The system according to claim 11, wherein the image processor is linked to the database through a network.

13. The system according to claim 11, wherein the protective layer is covered by a clear coat.

14. The system according to claim 11, wherein the protective layer is at least one of a fiberglass resin, a polyester resin and an epoxy resin.

15. A method of making an applique comprising:
selecting electronic image data with an image data source and processing the electronic image data;
printing an image to a recording medium with an image recording device, wherein the recording medium includes recording layer adhered to a substrate;
separating the recording layer with the image from the substrate and placing the recording layer on an object surface; and
applying a protective layer to the recording layer such that the image substantially remains the same and is not visually distorted as the protective layer permanently cures.

16. The method according to claim 15, wherein the method further comprises:
applying a clear coat over the protective layer.

17. The method according to claim 16, wherein the method further comprises:
applying an ultraviolet inhibitor to at least one of an ink, the protective layer and the clear coat.

18. The method according to claim 15, wherein the recording layer is adhered to the substrate by an adhesive having a low peeling force.

19. The method according to claim 15, wherein the image data source is connected to a database.

20. The method according to claim 15, wherein the image data source is connected to a database through a network.
